(19) United States
(12) Patent Application Publication
(10) Pub. No.: US 2008/0068496 A1
(43) Pub. Date: Mar. 20, 2008

(54) Broadcast program summary generation system, method and medium

(75) Inventors: Jin Guk Jeong, Yongin-si (KR); Eui Hyeon Hwang, Yongin-si (KR); Ki Wan Eom, Yongin-si (KR); Sang Kyun Kim, Yongin-si (KR); Ji Yeun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/715,374

(22) Filed: Mar. 8, 2007

(30) Foreign Application Priority Data
Sep. 20, 2006 (KR) 10-2006-0091038

(51) Int. Cl. H04N 7/01

(52) U.S. Cl. 348/441; 348/E07.003

(57) ABSTRACT

A broadcast program summary generation system, method and medium are provided. The broadcast program summary generation system includes a format transformation unit to transform a broadcast format of digital broadcast data into a storage format, and a summary generation unit to decode video data of the transformed digital broadcast data, to analyze the decoded video data, to detect an important event by analyzing audio data of the transformed digital broadcast data, and to generate summary information based on the important event.

### CROSS-REFERENCE TO RELATED APPLICATIONS

This application claims the benefit of Korean Patent Application No. 10-2006-0091038, filed on Sep. 20, 2006, in the Korean Intellectual Property Office, the disclosure of which is incorporated herein by reference.

### BACKGROUND

1. Field

One or more embodiments of the present invention relate to a broadcast program summary generation system, method and medium. More particularly, one or more embodiments of the present invention relate to a broadcast program summary generation system, method and medium, which can effectively generate broadcast program summary information by decoding a domain without decoding the entire domain, according to the type of broadcast data.

2. Description of the Related Art

As an example of a conventional broadcast program summary technique, a possible important event is detected using a Modified Discrete Cosine Transform (MDCT) coefficient extracted during encoding, and an exciting domain of high interest is extracted using audio information when an analog broadcast is recorded using a personal video recorder. However, in the conventional broadcast program summary technique, in the case of the analog broadcast, a broadcast program is summarized using a compressed domain feature, conversely a broadcast program summary method is not provided for a digital broadcast. Here, there may be no advantage in using the compressed domain information since uncompressed domain information may be used for the analog broadcast.

A summary is generated using motion information and color information in another example of a conventional broadcast program summary technique, a digital cache (DC) value is extracted from a compressed domain to generate a color histogram, and the motion information is extracted using a motion vector in B and P frames. However, the conventional broadcast program summary generation technique uses the DC value as the compressed domain feature, the DC value indicates an average of 8×8 block, in a case of a Motion Picture Experts Group (MPEG)-2 standard definition (SD) video, video resolution is 720×480, and thus 90×60 video is generated, which is not suitable for generating accurate summary information since the video resolution is too small to analyze.

As another example of a conventional broadcast program summary technique, a shot type of a baseball game program is divided using Bayes rule, field shape information, edge information, lawn information, amount of sand, camera motion, and players size information are used as feature values, and a change type of each shot type detected after using a hidden Markov model (HMM). However, with this conventional broadcast program summary technique there are problems in that the used feature values are so limited that performance is not good when the compressed domain feature is used, and processing speed may be decreased since decoding is required to be performed when the uncompressed domain feature is used.

### SUMMARY

One or more embodiments of the present invention provide a broadcast program summary generation system, method and medium which can reduce calculations by partially performing decoding operations depending upon whether a broadcast program is an analog broadcast or a digital broadcast.

One or more embodiments of the present invention also provide a broadcast program summary generation system, method and medium, which decodes compressed data according to each feature of various broadcasts, e.g., an analog broadcast, a digital broadcast, a high definition (HD) broadcast, and an SD broadcast, or extracts a DC image, detects an important event by analyzing the decoded data or the extracted DC image data, and generates and broadcasts program summary information using the detected important event.

Additional aspects and/or advantages of the invention will be set forth in part in the description which follows and, in part, will be apparent from the description, or may be learned by practice of the invention.

To achieve at least the above and/or other aspects and advantages, one or more embodiments of the present invention include a broadcast program summary generation system. The system includes a format transformation unit to transform a broadcast format of digital broadcast data into a storage format, and a summary generation unit to decode video data of the transformed digital broadcast data, to analyze the decoded video data, to detect an important event by analyzing audio data of the transformed digital broadcast data, and to generate summary information based on the important event.

To achieve at least the above and/or other aspects and advantages, one or more embodiments of the present invention include a broadcast program summary system. The system includes a digital broadcast tuner to receive digital broadcast data, an analog broadcast tuner to receive analog broadcast data, a format transformation unit to transform a broadcast format of the digital broadcast data into a storage format, and a summary generation unit to analyze the analog broadcast data or to decode the transformed digital broadcast data, to detect an important event as a result of the analyzing of the analog broadcast data or the decoding of the digital broadcast data, and to generate summary information based on the important event.

To achieve at least the above and/or other aspects and advantages, one or more embodiments of the present invention include a broadcast program summary generation method. The method includes transforming a broadcast format of digital broadcast data into a storage format, decoding video data of the transformed digital broadcast data to analyze the decoded video data, detecting an important event by analyzing audio data of the transformed digital broadcast data, and generating summary information based on the important event.

To achieve at least the above and/or other aspects and advantages, one or more embodiments of the present invention include a broadcast program summary generation method. The method includes receiving digital broadcast data or analog broadcast data, transforming a broadcast format of the digital broadcast data into a storage format, detecting an important event by analyzing at least one of the analog broadcast data and the transformed digital broadcast data, and generating summary information based on the important event.

To achieve at least the above and/or other aspects and advantages, one or more embodiments of the present invention include at least one medium comprising computer readable code to control at least one processing element to implement a broadcast program summary generation. The method includes transforming a broadcast format of digital broadcast data into a storage format, decoding video data of the transformed digital broadcast data, to analyze the decoded video data detecting an important event by analyzing audio data of the transformed digital broadcast data, and generating summary information based on the important event.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a digital broadcast program summary generation system according to an embodiment of the present invention;

FIG. 2 illustrates a summary generation unit, such as that of FIG. 1, according to an embodiment of the present invention;

FIG. 3 illustrates an analog broadcast program summary information generation system and a digital broadcast program summary information generation system according to an embodiment of the present invention;

FIG. 4 illustrates a summary generation unit, such as that illustrated in FIG. 3, according to an embodiment of the present invention;

FIG. 5 illustrates a digital broadcast program summary generation method according to an embodiment of the present invention;

FIG. 6 illustrates an operation of generating summary information, such as that illustrated in FIG. 5, according to an embodiment of the present invention;

FIG. 7 illustrates an operation of generating summary information of an analog broadcast program and a digital broadcast program according to an embodiment of the present invention;

FIG. 8 illustrates an operation of detecting an event candidate domain by analyzing video data of an uncompressed domain, such as that of FIG. 7, according to an embodiment of the present invention; and

FIG. 9 illustrates an operation of detecting the event candidate domain by analyzing video data of a compressed domain, such as that of FIG. 7, according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to like elements throughout. Embodiments are described below to explain the present invention by referring to the figures.

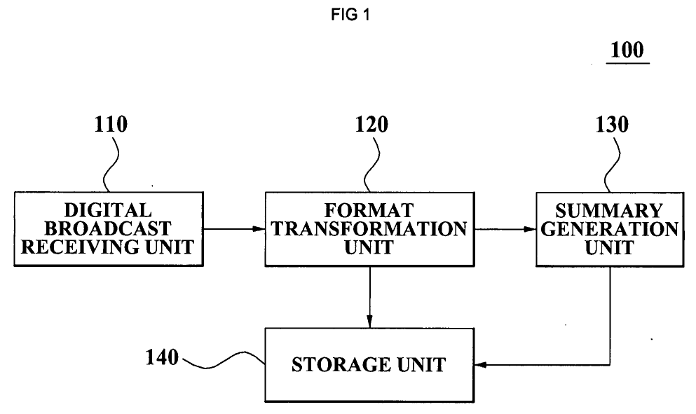

FIG. 1 illustrates a digital broadcast program summary generation system according to an embodiment of the present invention.

Referring to FIG. 1, the digital broadcast program summary generation system 100 may include a digital broadcast program receiving unit 110, a format transformation unit 120, a summary generation unit 130, and a storage unit 140, for example.

The digital broadcast program summary generation system 100 may receive digital broadcast data transmitted from a relayed digital broadcast. Here, as an example, the digital broadcast data may include various digital broadcast data, e.g., an Internet protocol television (IPTV), digital multimedia broadcasting (DMB), high definition television (HDTV). In one embodiment, the digital broadcast receiving unit 110 may include all units capable of receiving the digital broadcast data, including a digital broadcast tuner.

The format transformation unit 120 may transform a broadcast format of the digital broadcast data received via the digital broadcast receiving unit 110 into a storage format. In an embodiment, when the broadcast format of the received digital broadcast data is an MPEG-2 transport stream (TS), the format transformation unit 120, as an example, may transform the MPEG-2 TS into an MPEG-2 program stream (PS), i.e., an example of the storage format.

The summary generation unit 130 may detect an important event by analyzing the digital broadcast data after undergoing a minimized decoding operation, and may generate summary information of the digital broadcast program using the important event. As a specific example, the summary generation unit 130 decodes to analyze video data of the digital broadcast data, transformed into the storage format, detects the important event by analyzing audio data of the digital broadcast data, transformed into the storage format, and generates the summary information of the digital broadcast program using the important event.

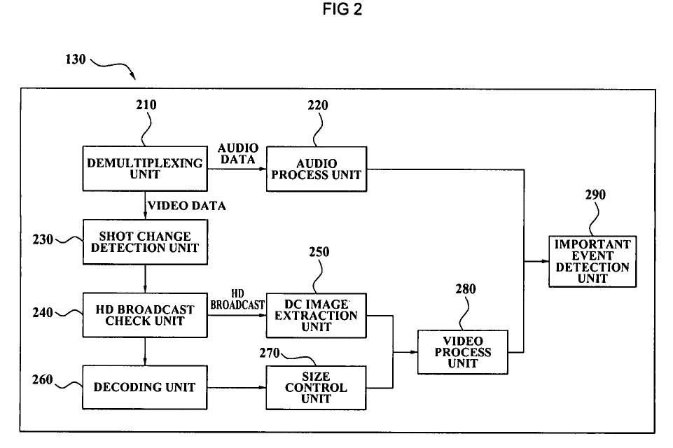

Hereinafter, an operation of the summary generation unit 130 will be described in more detail by referring to FIG. 2.

The storage unit 140 stores the digital broadcast data, transformed into the storage format, or the summary information of the digital broadcast program.

FIG. 2 illustrates the summary generation unit 130, such as illustrated in FIG. 1.

Referring to FIG. 2, the summary generation unit 130 may include a demultiplexing unit 210, an audio process unit 220, a shot change detection unit 230, an HD broadcast check unit 240, a digital cache (DC) image extraction unit 250, a decoding unit 260, a size control unit 270, a video process unit 280, and an important event detection unit 290, for example.

In the case of the digital broadcast data transformed into the storage format video data, the demultiplexing unit 210 demultiplexes the transformed digital broadcast data into video data of a compressed domain and audio data of a compressed domain in order to divide the transformed digital broadcast data into a video stream and an audio stream.

The audio process unit 220 may detect an event candidate domain by analyzing the audio data of the digital broadcast data, for example. The event candidate domain is a domain, e.g., of a digital broadcast program, where an important event is highly likely to occur. As an example, when the digital broadcast program is a baseball game broadcast, the event candidate domain may include a candidate domain capable of detecting the important event, e.g., a hit, a home run, or an out. The event may be detected, for example, because a commentator's voice tone changes when the important event occurs. Also, the audio process unit 220 may detect the event candidate domain of the audio data using dividers such as a Gaussian Mixture Model (GMM) and a Support Vector Machine (SVM), as further examples. The audio process unit 220 may also detect the event candidate domain of the audio data by analyzing a Modified Discrete Cosine Transform (MDCT) coefficient, i.e., an audio data feature of the compressed domain.

The shot change detection unit 230 may detect a shot change by analyzing the video data. In an embodiment, for a television broadcast, the shot change detection unit 230 may detect the shot change by analyzing the video data of the compressed domain since the shot differs according to a feature of each picture, e.g., an extremely long shot (ELS), a long shot (LS), a full shot (FS), a waist shot (WS), and a close up shot (CUS). Specifically, the shot change detection unit 230 may detect the shot change by analyzing the video stream of the compressed domain, and may extract one or two key frames, as an example, for representing each shot, depending upon the shot change. In the case of a 30 frames per second video, one shot may use two seconds of video, resulting in 60 consecutive frames. However, only two key frames need be extracted, whereupon only 1/30 of the video data would need to be subsequently processed.

The HD broadcast check unit 240 may check/determine whether the video data is HD broadcast data by analyzing the video data, for example. Specifically, the HD broadcast check unit 240 may determine the video data to be HD broadcast data when length×width size of the key frame is equal to or greater than a reference value. As an example, in the case of a full HD broadcast, the HD broadcast check unit 240 may establish the reference value as 1920×1080, since a key frame size of the full HD broadcast is 1920×1080. The HD broadcast check unit 240 may further determine if the broadcast data is greater than full HD broadcast data, i.e., enhanced digital broadcast data, based on whether the key frame size is equal to or greater than the reference value. As another example, in the case of an SD broadcast, the HD broadcast check unit 240 establishes the reference value as 720×480, since a key frame size of the SD broadcast is 720×480. Thus, the HD broadcast check unit 240 may determine the broadcast data is a low definition digital broadcast when the key frame size is less than the reference value.

When the video data is HD broadcast data, the summary generation unit 130 may extract a DC image from the video data via the DC image extraction unit 250, for example.

In the case of an MPEG-2 video format, for example, used in the digital broadcast, the DC image may correspond to an average value of an 8×8 block and a value representing a feature of the 8×8 block. The DC image may be transformed to have a frame size of the video data reduced to ⅛ of its original size. Namely, the DC image extraction unit 250 may extract a DC image of 240×135 size when the video data is a full HD broadcast since a key frame size of the full HD broadcast is 1920×1080. As described above, the summary generation unit 130 may reduce processing time since a DC image having a reduced size is extracted from a compressed video stream via the DC image extraction unit 250, without the decoding operation. Conversely a large amount of time is required for a conventional decoding operation, such as for HD broadcast data, because the frame size of the video data is great.

The summary generation unit 130 may decode the video data via the decoding unit 260 when the video data is not HD broadcast data. Namely, the decoding unit 260 may decode the video data of the compressed domain when the video data is not HD broadcast data. It takes less time to decode the video data for SD broadcast data than for HD broadcast data because of the lower capacity of the SD broadcast data. Also, the decoding unit 260 may reduce the entire decoding time by decoding only one frame from the video data of the compressed domain, since the decoding time of B and P frames is the most time consuming part of the entire decoding operation.

The size control unit 270 may control a frame size of the decoded video data to be a manageable size for processing in the video process unit 280. Specifically, the size control unit 270 may reduce the frame size of the decoded video data when the frame size of the decoded video data is greater than a manageable size in the video process unit 280. In one embodiment, the size control unit 270 need not operate when the frame size of the decoded video data is less than or equal to a manageable size in the video process unit 280, thus allowing the operation of the size control unit 270 to be omitted.

The video process unit 280 may detect an event candidate domain by analyzing the DC image or the decoded video data. For example, the event candidate domain may include a close-up shot or a penalty shot, which are likely to be important scoring events. As another example, the video process unit 280 may detect the event candidate domain such as a close-up shot or a penalty shot by analyzing the DC image or the decoded video data when the digital broadcast program is a soccer game broadcast.

The important event detection unit 290, thus, may detect the important event by analyzing the event candidate domain. Further, the important event detection unit 290 may generate a summary of the digital broadcast data using the detected important event.

As described above, the digital broadcast program summary generation system 100 of FIG. 1 may extract the DC image without performing the decoding when video data is high capacity data, such as an HD broadcast, and may perform the decoding when video data is low capacity data, i.e., when the video data capacity is less than an HD broadcast, and thus processing speed for generating summary information of the digital broadcast data may be enhanced.

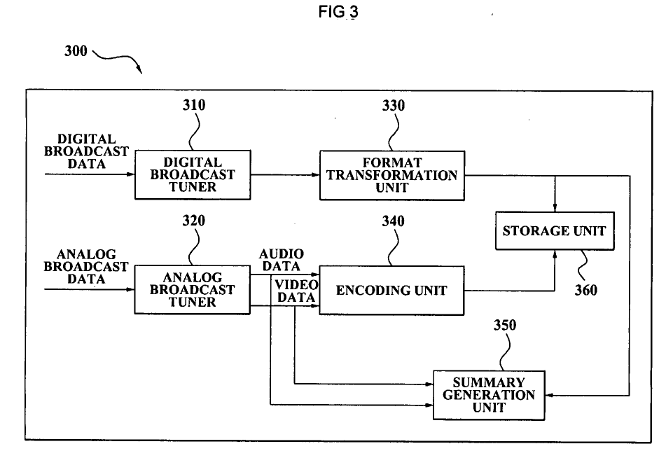

FIG. 3 illustrates an analog broadcast program summary information generation system and a digital broadcast program summary information generation system according to another embodiment of the present invention.

Referring to FIG. 3, a broadcast program summary information generation system 300 may include a digital broadcast tuner 310, an analog broadcast tuner 320, a format transformation unit 330, an encoding unit 340, a summary generation unit 350, and a storage unit 360, for example.

In an embodiment, the broadcast program summary information generation system 300 receives digital broadcast program data via the digital broadcast tuner 310, and receives analog broadcast program data via the analog broadcast tuner 320. The digital broadcast data may include various digital broadcast data such as any one of an Internet protocol television (IPTV), a digital multimedia broadcasting (DMB), and a high definition television (HDTV), for example. Specifically, the broadcast program summary information generation system 300 receives the digital broadcast data via the digital broadcast tuner 310 when a user wants to view the digital broadcast, and receives the analog broadcast data via the analog broadcast tuner 320 when the user wants to view the analog broadcast. The broadcast program summary information generation system 300 receives the digital broadcast data via the digital broadcast tuner 310 in a location capable of receiving the digital broadcast, and receives the analog broadcast data via the analog broadcast tuner 320 in a location capable of receiving the analog broadcast. The broadcast program summary information generation system 300 may receive the digital broadcast data and/or the analog broadcast data according to the user's selection, or as determined by the broadcast program summary information generation systems 300 itself, for example.

The format transformation unit 330 may transform a broadcast format of the digital broadcast data into a storage format. Specifically, the format transformation unit 330 transforms the broadcast format of the digital broadcast data into the storage format via the digital broadcast tuner 310. As an example, when the broadcast format of the received digital broadcast data is an MPEG-2 TS, the format transformation unit 330 may transform the MPEG-2 TS into an MPEG-2 PS, noting that these are only examples of storage formats.

The encoding unit 340, thus, may encode the analog broadcast data received via the analog broadcast tuner 320 into an appropriate digital format. In an embodiment, the encoding unit 340 may encode the analog broadcast data into the MPEG-2 PS format.

The summary generation unit 350 may analyze the analog broadcast data or decode to analyze the digital broadcast data, transformed into the storage format, detect an important event of the digital broadcast data or analog broadcast data according to the above analysis, and generate summary information of the digital broadcast data or the analog broadcast data using the important event.

In another embodiment, the storage unit 360 may store the digital broadcast data transformed by the format transformation unit 330, the analog broadcast data encoded by the encoding unit 340 and the summary information of the digital broadcast data or the analog broadcast data generated by the summary generation unit 350.

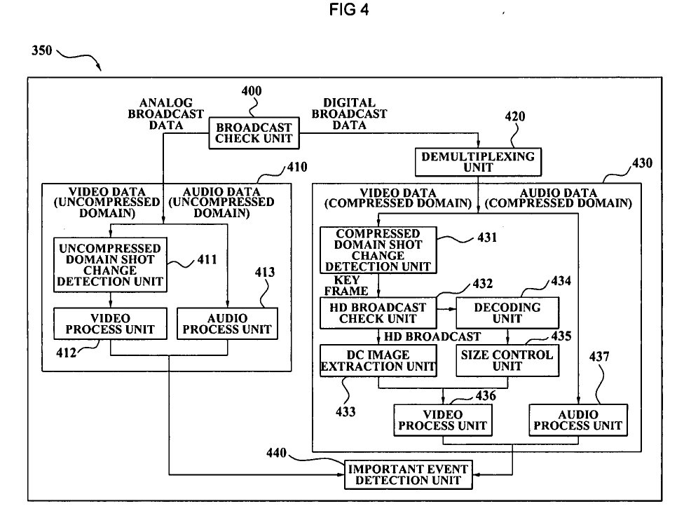

FIG. 4 illustrates the summary generation unit 350, such as that illustrated in FIG. 3.

In one embodiment, referring to FIG. 4, the summary generation unit 350 of FIG. 3 may include an analog broadcast process unit 410, a demultiplexing unit 420, a digital broadcast process unit 430, and an important event detection unit 440, for example.

A broadcast check unit 400 checks/determines whether broadcast data, e.g., received from the summary generation unit of FIG. 3, is analog broadcast data or digital broadcast data. Specifically, the broadcast check unit 400 may identify the received broadcast data to be digital broadcast data when the broadcast data is received via the digital broadcast tuner 310 of FIG. 3, and may identify the received broadcast data as being analog broadcast data when the broadcast data is received via the analog broadcast tuner 320 of FIG. 3, for example.

The analog broadcast process unit 410 may detect the event candidate domain by respectively analyzing video data and audio data of an uncompressed domain of the analog broadcast data when the received data is analog broadcast data. The analog broadcast data may be divided into video data of the uncompressed domain and audio data of the uncompressed domain before the analog broadcast data is encoded into a digital format, e.g., by the encoding unit 340 of FIG. 3.

The analog broadcast process unit 410 may include an uncompressed domain shot change detection unit 411, a video process unit 412, and an audio process unit 413, for example. The uncompressed domain shot change detection unit 411 detects a shot change by analyzing the video data of the uncompressed domain, i.e., the analog broadcast data. Specifically, the uncompressed domain shot change detection unit 411 may detect the shot change, for example, using a Euclidean distance of a color histogram of the video data in an uncompressed domain, i.e., before the analog broadcast data is encoded by the encoding unit 340, or edge information of the uncompressed domain is determined. The video process unit 412 may divide each shot depending upon the detected shot change, and may detect the event candidate domain of the video data for the analog broadcast data by analyzing each shot. Namely, the video process unit 412 may detect the event candidate domain of the video data, e.g., an important event like a close-up shot or a penalty shot, by analyzing each shot when the video data is a soccer game broadcast, for example. The audio process unit 413 may detect the event candidate domain of the audio data by analyzing the audio data of the uncompressed domain of the analog broadcast data. Specifically, in the example of a soccer game, the audio process unit 413 may detect the event candidate domain of the audio data, by detecting an exclamation or high voice tension, since a commentator likely raises his or her voice when there is a goal. Also, the audio event process unit 413 may detect the event candidate domain of the audio event by analyzing PCM data, i.e., the audio data of the uncompressed domain.

The demultiplexing unit 420 demultiplexes the digital broadcast data into video data and audio data when the received broadcast data is digital broadcast data.

The digital broadcast process unit 430 may decode the video data of the compressed domain of the digital broadcast data to analyze the decoded video data, and detect the event candidate domain of the digital broadcast data by analyzing the audio data of the compressed domain of the digital broadcast data.

The digital broadcast process unit 430 may further include a compressed domain shot change detection unit 431, an HD broadcast check unit 432, a DC image extraction unit 433, a decoding unit 434, a size control unit 435, a video process unit 436, and an audio process unit 437, for example.

The compressed domain shot detection unit 431 detects a shot change using the video data of the decoded compressed domain, and extracts a key frames of each shot according to the detected shot change.

The HD broadcast check unit 432 checks/determines, using the key frame, whether the video data of the compressed domain is HD broadcast data, according to the detected shot change. Specifically, the HD broadcast check unit 432 may determine the video data to be HD broadcast data when length×width size of the key frame extracted from the video data is equal to or greater than a reference. As an example, in the case of a full HD broadcast, the HD broadcast check unit 432 establishes the reference value as 1920×1080 since a key frame size of the full HD broadcast is 1920×1080. The HD broadcast check unit 432 may determine if the broadcast data is greater than full HD broadcast data, i.e., enhanced digital broadcast data, based on whether the key frame size is equal to or greater than the reference value. As another example, in the case of an SD broadcast, the HD broadcast check unit 432 establishes the reference value as 720×480, since a key frame size of the SD broadcast is 720×480. Thus, the HD broadcast check unit may determine the broadcast data is a low definition digital broadcast data when the key frame size is less than the reference value.

The summary generation unit 350 of FIG. 3 may extract a DC image from the video data via the DC image extraction unit 433 when the video data is HD broadcast data.

In one embodiment, in the case of an MPEG-2 video format used in the digital broadcast, the DC image-omit corresponds to an average value of an 8×8 block and a value representing a feature of the 8×8 block. The DC image may be transformed so that the frame size of the video data is reduced to ⅛ its original size. Namely, the DC image extraction unit 433 may extract a DC image of 240×135 size when the video data is full HD broadcast data, since a key frame size of the full HD broadcast is 1920×1080. As described above, the summary generation unit 350 may reduce processing time since a reduced DC image may be extracted from a compressed video stream via the DC image extraction unit 433, without the aforementioned decoding operation. Conversely a large amount of time is required for a conventional decoding operation, such as for HD broadcast data, because the frame size of the video data is great.

The summary generation unit 350 of FIG. 3 may decode the video data via the decoding unit 434 when the video data is not HD broadcast data. Namely, the decoding unit 434 may decode the video data of the compressed domain when the video data is not HD broadcast data. It takes less time to decode the video data for SD broadcast data than for HD broadcast data because of the lower capacity of the SD broadcast data. Also, the decoding unit 434 may reduce the entire decoding time by decoding only one frame from the video data of the compressed domain since the decoding time of B and P frames is the most time consuming part of the entire decoding operation.

The size control unit 435 may control a frame size of the decoded video data to be a manageable size for processing in the video process unit 436. Specifically, the size control unit 435 may reduce the frame size of the decoded video data when the it is greater than a manageable size in the video process unit 436. Also, the size control unit 435 need not operate when the frame size of the decoded video data is the less than or equal to a manageable size in the video process unit 436, allowing the operation of the size control unit 435 to be omitted.

The video process unit 436 may detect an event candidate domain by analyzing the DC image or the decoded video data. For example, the event candidate domain may include a close-up shot domain or a penalty shot domain, which are likely to be important scoring events. When the digital broadcast data is a soccer game broadcast, for example, a scoring shot is typically the most important event. As another example, the video process unit 436 may detect the event candidate domain, such as a close-up shot or a penalty shot, by analyzing the DC image or the decoded video data when the digital broadcast program is the soccer game broadcast.

The audio process unit 437 may detect an event candidate domain by analyzing the audio data of a compressed domain, for example. The event candidate domain is a domain, e.g., of a digital broadcast program, where an important event is highly likely to occur. As an example, voice tone of a commentator changes when an important event occurs, for example when the digital broadcast program is a baseball game broadcast. Therefore the event candidate domain may include a candidate domain capable of detecting the important event, e.g., a hit, a home run, and an out. Further, the audio process unit 437 may detect the event candidate domain of the audio data by analyzing an MDCT coefficient, i.e., an audio data feature of the compressed domain. Finally, the audio process unit 437 may detect the event candidate domain of the audio data using dividers such as a GMM and an SVM, as further examples. Alternate embodiments are equally available.

The important event detection unit 440 detects the important event by analyzing the event candidate domain of the analog broadcast data or the digital broadcast data. In addition, the important event detection unit 440 may generate a summary of the digital broadcast data using the detected important.

As described above, the broadcast program summary generation system 300 of FIG. 3 may generate summary information of a digital broadcast program, and also may generate summary information of an analog broadcast program. In the case of a digital broadcast, processing speed may be enhanced because a decoding operation is performed only for a required domain, since the DC image is extracted or the decoding operation is performed depending upon a capacity of the digital broadcast.

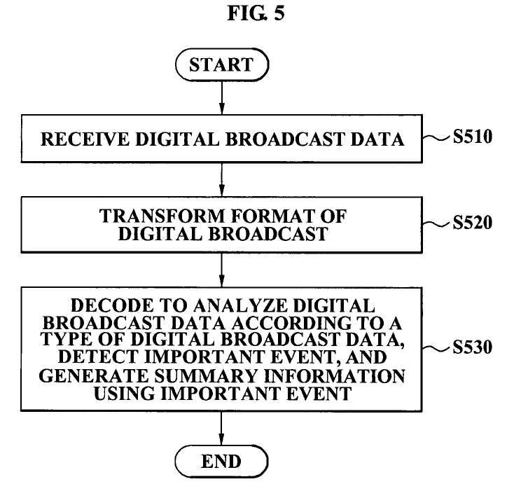

FIG. 5 illustrates a digital broadcast program summary information generation method according to an embodiment of the present invention.

Referring to FIG. 5, a digital broadcast program summary information generation system, such as that of 300 of FIG. 3, receives digital broadcast data in operation S510. Specifically, in operation S510, the digital broadcast program summary information generation system 300 may receive digital broadcast data, e.g., transmitted from a digital broadcast relay in a broadcast station via a digital broadcast tuner 310 of FIG. 3, for example.

In operation S520, in one embodiment, the digital broadcast program summary information generation system 300 of FIG. 3, for example, may transform digital broadcast data in an MPEG-2 TS format into an MPEG-2 PS format. An example of the storage format used is MPEG-2 TS, when a broadcast format of the digital broadcast data is received, noting that alternate formats are also available.

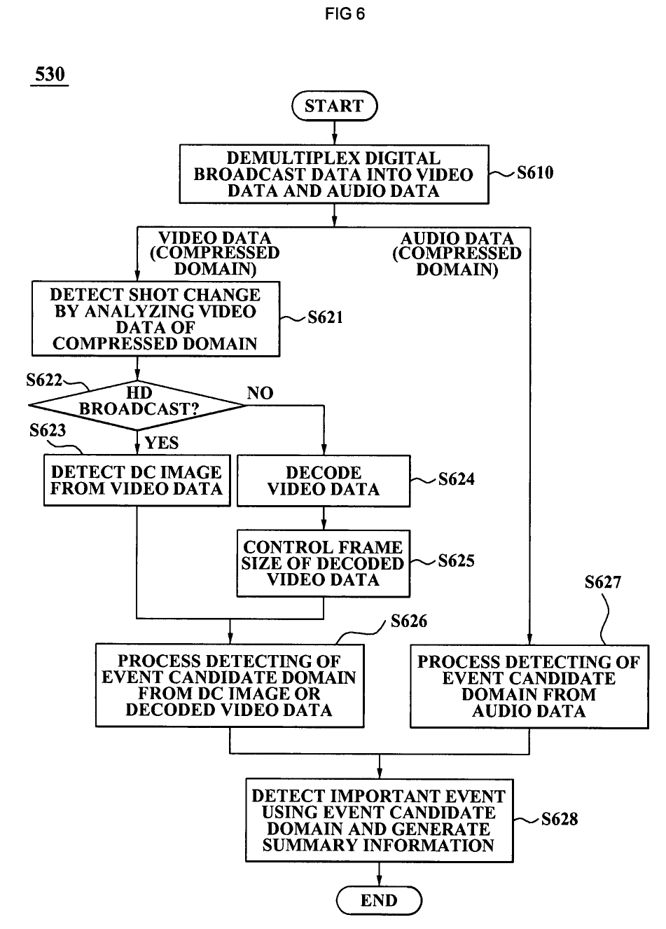

In operation S530, such a digital broadcast program summary information generation system 300 may decode the digital broadcast data into video data or audio data to analyze the decoded video data. The program then detects an important event by analyzing audio data of the digital broadcast data, transformed into the storage format, and generates summary information using the important event. Hereinafter, the above generating operation will be described in more detail by referring to FIG. 6.

FIG. 6 illustrates an operation of generating summary information, such as illustrated in FIG. 5.

Referring to FIG. 6, in operation S610, the digital broadcast data may be demultiplexed into video data and audio data of a compressed domain, e.g., by the digital broadcast program summary information generation system 300 of FIG. 3. In one embodiment, the digital broadcast program summary information generation system 300 may demultiplex the digital broadcast data into video data and audio data of a compressed domain by analyzing MPEG-2 PS data when the digital broadcast data is MPEG-2 PS.

In operation S621, a shot change may be detected by analyzing the video data of the compressed domain and extracting a key frame according to the shot change, e.g., by the digital broadcast program summary information generation system 300 of FIG. 3.

In operation S622, it may be determined whether the video data of the compressed domain is HD broadcast data by analyzing the key frame, e.g., by the digital broadcast program summary information generation system 300 of FIG. 3. In an embodiment, the digital broadcast program summary information generation system 300 may determine whether the video data is HD broadcast data by comparing length×width size of the key frame with a reference value. In operation S622, the digital broadcast program summary information generation system 300 may determine the video data as HD broadcast data via the HD broadcast check unit 432, such as of FIG. 4, when the length×width size of the key frame is greater than the reference value by comparing the length×width size of the key frame with the reference value. As an example, in the case of a full HD broadcast, the HD broadcast check unit 240 may establish the reference value as 1920×1080, since a key frame size of a full HD broadcast is 1920×1080, and may determine the broadcast data is greater than the full HD broadcast data, i.e. as an enhanced digital broadcast data, when the key frame size is greater than the reference value. As another example, in the case of a SD broadcast, the HD broadcast check unit 240 may establish the reference value as 1920×1080 since a key frame size of the SD broadcast is 720×480, and may identify the broadcast data as low definition digital broadcast data when the key frame size is less than the reference value.

In operation S623, a DC image may be extracted from the video data of the compressed domain when the video data of the compressed domain is HD broadcast data e.g., by the digital broadcast program summary information generation system 300 of FIG. 3. In one embodiment, the digital broadcast program summary information generation system 300 may extract the DC image from the video data of the compressed domain using the DC image extraction unit 433, such as of FIG. 4. In one example, the DC image-omit corresponds to an average value of an 8×8 block and a value representing a feature of the 8×8 block. The DC image is transformed to have a frame size of the video data reduced to ⅛ of its original size. In another example, the digital broadcast program summary information generation system 300 may extract a DC image of 240×135 size when the video data is full HD broadcast since a key frame size of the full HD broadcast is 1920×1080.

As described above, a digital broadcast program summary information generation method, according to an embodiment of the present invention, may reduce processing time because the DC image is extracted from a compressed video stream without a decoding operation, resulting in a reduced image size. Conversely, a large amount of time is required for a conventional decoding operation, such as for HD broadcast data, because the frame size of the video data is great.

In operation S624, the video data of the compressed domain may be decoded when the video data of the compressed domain is not HD broadcast data e.g., by the digital broadcast program summary information generation system 300 of FIG. 3. In an example, when the video data is SD broadcast data, less time is needed to decode SD broadcast data than to decode HD broadcast data because of the lower capacity of the SD broadcast data. In another example, in operation S624, the digital broadcast program summary information generation system 300 may reduce the entire decoding time by decoding only one frame from the video data of the compressed domain, since the decoding time of B and P frames is the most time consuming part of the entire decoding operation.

In operation S625, a frame size of the decoded video data may be maintained at a manageable size for processing to detect an event candidate domain of the video data, e.g., by the digital broadcast program summary information generation system 300 of FIG. 3. In one embodiment, in operation S625, the digital broadcast program summary information generation system 300 may reduce the frame size of the decoded video data when the frame size of the decoded video data is greater than a manageable size to facilitate detection of the event candidate domain of the video data. Conversely, the digital broadcast program summary information generation system 300 need not operate when the frame size of the decoded video data is less than or equal to a manageable size, wherein operation S625 may be omitted.

In operation S626, an event candidate domain may be detected by analyzing the DC image or the decoded video data, e.g., by the digital broadcast program summary information generation system 300. In one embodiment, in operation S626, the digital broadcast program summary information generation system may detect an event candidate domain such as a close-up shot or a penalty shot by analyzing the DC image or the decoded video data when the digital broadcast program is a soccer game broadcast, for example.

In operation S627, an event candidate domain may be detected by analyzing audio data, e.g., by the digital broadcast program summary information generation system 300. In one embodiment, in operation S627, when the digital broadcast program is a baseball game, as an example, the event candidate domain may be detected by a change in a commentator's voice tone, often accompanying an important event, such as a hit, a home run, and an out, for example. Further, in the operation S627, the digital broadcast program summary information generation system may detect the event candidate domain of the audio data by analyzing an MDCT coefficient, i.e., an audio data feature of the compressed domain. In the operation S627, the digital broadcast program summary information generation system may detect the event candidate domain of the audio data using dividers such as a GMM and an SVM, as further examples.

In operation S628, the important event may be detected by analyzing the event candidate domain, and generating summary information of the digital broadcast data using the important event, e.g., by the digital broadcast program summary information generation system 300.

As described above, the digital broadcast program summary information generation method according to one or more embodiments of the present invention may reduce processing time to generate summary information because a DC image is extracted without performing a decoding operation when the broadcast data is greater than full HD broadcast data, for example, enhanced digital broadcast data. Conversely, the decoding operation is performed when the broadcast data is less than full HD broadcast data, for example, SD broadcast data.

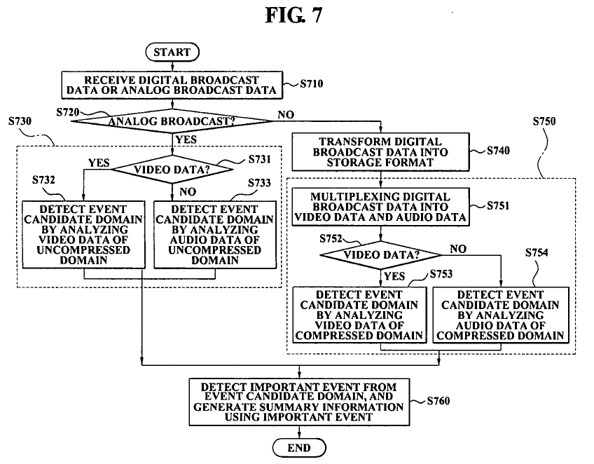

FIG. 7 illustrates an operation of generating summary information of an analog broadcast program and a digital broadcast program according to another embodiment of the present invention.

Referring to FIG. 7, digital broadcast data or analog broadcast data may be received in operation S710. In one embodiment, digital broadcast program data may be received via a digital broadcast tuner, and analog broadcast program data may be received via an analog broadcast tuner in operation S710.

In operation S720, whether the received broadcast data is analog broadcast data or digital broadcast data is determined by analyzing the format of the received broadcast data.

In operation S730, the analog broadcast data is analyzed, and an event candidate domain of the analog broadcast data is detected. Operation S730 includes operation S731 and operation S733, as will be described in greater detail below.

In operation S731, it is determined whether the analog broadcast data is video data or audio data.

When the analog data is video data, the event candidate domain of the analog broadcast data may be detected by analyzing the video data of an uncompressed domain in operation S732.

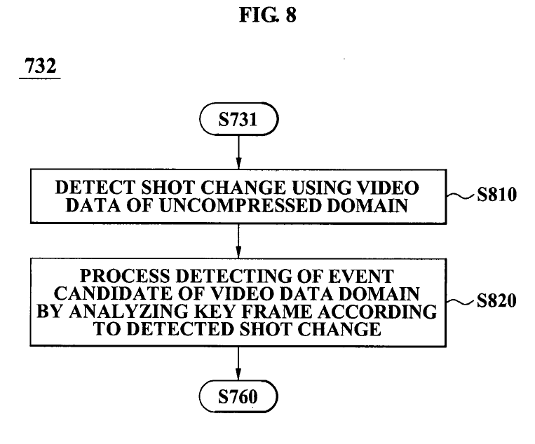

The detecting of the event candidate domain of the analog broadcast data will be described in detail by referring to FIG. 8.

FIG. 8 illustrates the detecting of the event candidate domain by analyzing video data of an uncompressed domain, such as in FIG. 7.

Referring to FIG. 8, a shot change may be detected from the video data of the uncompressed domain in operation S810. In an embodiment, a broadcast program summary generation system may detect the shot change, for example, using a Euclidean distance of a color histogram of the video data in the uncompressed domain or edge information of the uncompressed domain in operation S810.

In operation S820, each shot may be divided according to the detected shot change, and the event candidate domain of the video data may be detected by analyzing each shot. In an embodiment, a broadcast program summary generation system may detect the event candidate domain of the video data, e.g. a close-up shot or a penalty shot, by analyzing each shot, when the video data is a soccer game broadcast, for example.

When the analog broadcast data is audio data, an event candidate domain of the analog broadcast data may be detected by analyzing the audio data of the uncompressed domain in operation S733.

In operation S740, broadcast format of the digital broadcast data may be transformed into a storage format. In an embodiment, a broadcast program summary generation system may demultiplex the digital broadcast data into video data of the compressed domain and audio data of the compressed domain by analyzing an MPEG-2 PS, when the digital broadcast data is MPEG-2 PS, for example.

In operation S750, the event candidate domain may be detected by analyzing the digital broadcast data, transformed into the storage format. Specifically, operation S750 may include operations S751 through S754.

In the operation S751, the digital broadcast data may be demultiplexed into a video data stream and an audio data stream.

In operation S752, it may be determined whether demultiplexed digital broadcast data is video data.

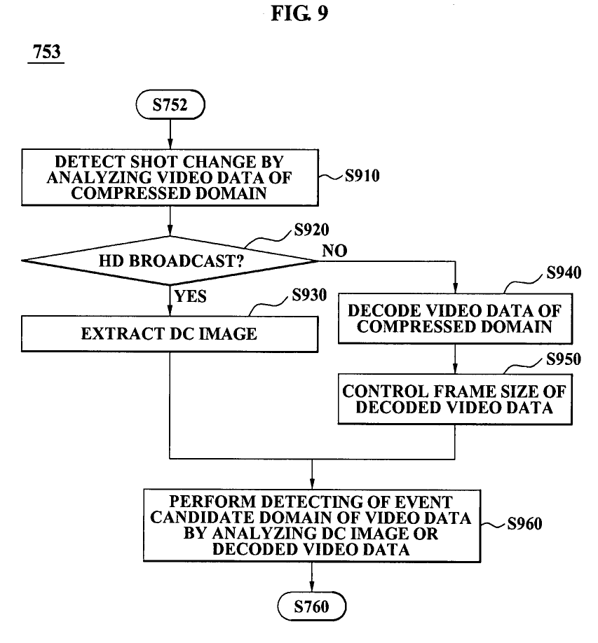

When the digital broadcast data is video data, the event candidate domain may be detected by analyzing the video data of the compressed domain in operation S753. The detecting of the event candidate domain will be described in more detail below by referring to FIG. 9.

FIG. 9 illustrates the detecting of the event candidate domain by analyzing the video data of the compressed domain of FIG. 7.

Referring to FIG. 9, a shot change may be detected by analyzing the video data of the compressed domain, and may extract a key frame according to the shot change, in operation S910.

In operation S920, it may be determined whether the video data of the compressed domain is broadcast data by analyzing the key frame. In operation S920, the video data of the compressed domain is determined to be HD broadcast data by comparing length×width size of the key frame with a reference value. In operation S920, an HD broadcast check unit may determine the video data to be HD broadcast data when the length×width size of the key frame is found to be greater than the reference value. As an example, in the case of a full HD broadcast, the HD broadcast check unit may establish the reference value as 1920×1080 because a key frame size for a full HD broadcast is 1920×1080. Further, the HD broadcast check unit may determine the broadcast data is enhanced digital broadcast data when the key frame size is greater than the reference value. As another example, in the case of an SD broadcast, the HD broadcast check unit 240 may establish the reference value as 720×480, because a key frame size for an SD broadcast is 720×480, and may determine the broadcast data is low definition digital broadcast data when the key frame size is less than the reference value.

When the video data is HD broadcast data, a DC image is extracted from the video data of the compressed domain in operation S930. In one embodiment, in the case of an MPEG-2 video format used in the digital broadcast, the DC image may correspond to an average value of an 8×8 block and a value representing a feature of the 8×8 block. The DC image may be transformed to have a frame size of the video data reduced to ⅛ of its original size. Namely, the DC image extraction unit 433 may extract a DC image of 240×135 size when the video data is a full HD broadcast since a key frame size of the full HD broadcast is 1920×1080.

As described above, according to an embodiment of the present invention, processing time may be reduced since a reduced DC image may be extracted from a compressed video stream via the DC image extraction unit without a decoding operation. Conversely a large amount of time is required for a conventional decoding operation because the frame size of the video data is great.

When the video data is not HD broadcast data, the video data of the compressed domain may be decoded, as in operation S940. Specifically, when the video data is SD broadcast data, it takes less time to decode video data for the SD broadcast data than for the HD broadcast data because of the lower capacity of the SD broadcast data. Also, in operation S940, the entire decoding time may be reduced by decoding only one frame from the video data of the compressed domain since the decoding time of B and P frames, for example, is the most time consuming part of the entire decoding operation.

In operation S950, a frame size of the decoded video data is maintained at a manageable size for processing to detect the event candidate domain of the video data. Specifically, in operation S950, the frame size of the decoded video data may be reduced when the frame size of the decoded video data is greater than a manageable size, to detect the event candidate domain of the video data. Conversely, operation S950 need not be performed when the frame size of the decoded video data is less than or equal to a manageable size.

In operation S960, the event candidate domain may be detected using the DC image or by analyzing the decoded video data. Namely, the event candidate domain such as a close-up shot or a penalty shot may be detected by analyzing the DC image or the decoded video data when the digital broadcast program is a soccer game broadcast, for example. Conversely, when the digital broadcast data is audio data, an event candidate domain may be detected by analyzing the audio data of a compressed domain in operation S754. As an example, when the digital broadcast program is a baseball game, the event candidate domain may be detected because a commentator's voice tone changes when the important event, e.g., a hit, a home run, and an out, occurs. Further, in operation S754, the event candidate domain of the audio data may be detected by analyzing, for example, an MDCT coefficient, i.e., an audio data feature of the compressed domain. The event candidate domain of the audio data may be detected using dividers such as a GMM and an SVM, as further examples.

In operation S760, the digital broadcast data may be decoded, transformed into a storage format, the decoded digital broadcast data may be analyzed, the important event according to the analyzed result may be detected, and summary information of the analog broadcast program or summary information of the digital broadcast program may be generated using the important event, for example.

As described above, summary information of a digital broadcast program, and of an analog broadcast program may be generated. In the case of the digital broadcast, processing speed may be enhanced because a decoding operation is performed only in a required domain, since a DC image is extracted or a decoding operation is performed depending upon a capacity of the digital broadcast.

In addition to this discussion, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only a example, the processing element could include a processor or a computer processor, and processing elements may be distributed and/or included in a single device.

According to the present invention, there is provided a broadcast program summary generation system, method and medium, which can reduce calculations by partially performing decoding operations depending upon whether a broadcast program is an analog broadcast or a digital broadcast.

Also, according to the present invention, there is provided a broadcast program summary generation system, method and medium, which decodes compressed data according to each feature of various broadcasts, e.g. an analog broadcast, a digital broadcast, an HD broadcast, and an SD broadcast, or extracts a DC image, detects an important event by analyzing the decoded data or the extracted DC image data, and generates and broadcasts program summary information using the detected important event.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A broadcast program summary generation system comprising:
a format transformation unit to transform a broadcast format of digital broadcast data into a storage format; and
a summary generation unit to decode video data of the transformed digital broadcast data, to analyze the decoded video data, to detect an important event by analyzing audio data of the transformed digital broadcast data, and to generate summary information based on the important event.

2. The system of claim 1, wherein the summary generation unit further comprises:
a demultiplexing unit to demultiplex the digital broadcast data into video data and audio data;
a shot change detection unit to detect a shot change by analyzing the video data;
a high definition (HD) broadcast check unit to check whether the video data is HD broadcast data by analyzing the video data;
a decoding unit to decode the video data when the video data is not the HD broadcast data;
a digital cache (DC) image extraction unit to extract a DC image from the video data when the video data is the HD broadcast data;
a video process unit to detect an event candidate domain by analyzing at least one of the extracted DC image and the decoded video data; and
an important event detection unit to detect the important event by analyzing the event candidate domain.

3. The system of claim 2, wherein the shot change detection unit extracts a key frame from each shot, divided according to the detected shot change.

4. The system of claim 2, wherein the HD broadcast check unit determines the video data to be the HD broadcast data when length×width size of the key frame is greater than a reference value, by comparing the length×width size of the key frame with the reference value.

5. A broadcast program summary system comprising:
a digital broadcast tuner to receive digital broadcast data;
an analog broadcast tuner to receive analog broadcast data;
a format transformation unit to transform a broadcast format of the digital broadcast data into a storage format; and
a summary generation unit to analyze the analog broadcast data or to decode the transformed digital broadcast data, to detect an important event as a result of the analyzing of the analog broadcast data or the decoding of the digital broadcast data, and to generate summary information based on the important event.

6. The system of claim 5, wherein the summary generation unit further comprises:
a broadcast check unit to determine whether the received broadcast data is the analog broadcast data or the digital broadcast data;
an analog broadcast process unit to detect an event candidate domain by respectively analyzing video data and audio data of an uncompressed domain from the analog broadcast data;
a digital broadcast process unit to decode the video data of the compressed domain of the digital broadcast data and to detect an event candidate domain of the digital broadcast data by analyzing the audio data of the compressed domain of the digital broadcast data; and
an important event detection unit to detect an important event by analyzing the event candidate domain of at least one of the analog broadcast data and the digital broadcast data.

7. The system of claim 6, wherein the analog broadcast process unit comprises:
an uncompressed domain shot change detection unit to detect one or more shot changes by analyzing the video data of the uncompressed domain of the analog broadcast data;
a video process unit to divide each shot according to the detected one or more shot changes, and to perform the detecting of the event candidate domain of the video data of the uncompressed domain of the analog broadcast data by analyzing each shot; and
an audio process unit to perform the detecting of the event candidate domain of the audio data by analyzing the audio data of the uncompressed domain of the analog broadcast data.

8. The system of claim 6, wherein the digital broadcast process unit comprises:
a compressed shot change detection unit to detect the shot change based on the video data of the compressed domain;
an HD broadcast check unit to determine whether the video data of the compressed domain is HD broadcast data using a key frame according to the detected shot change;
a DC image extraction unit to extract a DC image from the video data of the compressed domain when the video data is the HD broadcast data;
a decoding unit to decode the data of the compressed domain when the data of the compressed domain data is not the HD broadcast data;
a video process unit to perform the detecting of the event candidate domain of the video data of the compressed domain by analyzing the decoded data or the extracted DC image; and
an audio process unit to perform the detecting of the event candidate domain of the audio data by analyzing the audio data of the compressed domain.

9. The system of claim 8, further comprising:
a size control unit to control a frame size of the decoded video data into a processable size for the video process unit.

10. The system of claim 8, further comprising:
a demultiplexing unit to demultiplex the digital broadcast data into the video data of the compressed domain and the audio data of the compressed domain.

11. The system of claim 8, wherein the HD broadcast check unit determines whether the video data of the compressed domain is the HD broadcast data by comparing the length×width size of the key frame with a reference value.

12. A broadcast program summary generation method comprising:
transforming a broadcast format of digital broadcast data into a storage format;
decoding video data of the transformed digital broadcast data to analyze the decoded video data;
detecting an important event by analyzing audio data of the transformed digital broadcast data; and
generating summary information based on the important event.

13. The method of claim 12, wherein the generating of the summary information based on the important event further comprises:
demultiplexing the digital broadcast data into the video data and the audio data of a compressed domain;
detecting a shot change by analyzing the video data of the compressed domain, and extracting a key frame according to the shot change;
determining whether the key frame is HD broadcast data by analyzing the key frame;
decoding the video data of the compressed domain when the video data of the compressed domain is not the HD broadcast data;
extracting a DC image from the video data of the compressed domain when the video data of the compressed domain is the HD broadcast data;
detecting an event candidate domain by analyzing the extracted DC image and the decoded video data; and
detecting the important event by analyzing the event candidate domain, and generating the summary information of the digital broadcast data based on the important event.

14. The method of claim 13, wherein the determining of whether the key frame is the HD broadcast data by analyzing the key frame determines the video data as the HD broadcast data when a length×width size of the key frame are greater than a reference value by comparing the length×width size of the key frame with the reference value.

15. A broadcast program summary generation method comprising:
receiving digital broadcast data or analog broadcast data;
transforming a broadcast format of the digital broadcast data into a storage format;
detecting an important event by analyzing at least one of the analog broadcast data and the transformed digital broadcast data; and
generating summary information based on the important event.

16. The method of claim 15, wherein the generating of the summary information comprises:
determining whether the received broadcast data is the analog broadcast data or the digital broadcast data;
detecting an event candidate domain by respectively analyzing the video data and audio data of an uncompressed domain of the analog broadcast data;
analyzing at least one of a decoded result and an extracted result by decoding the video data of the compressed domain of the digital broadcast data or extracting a DC image, and detecting the event candidate domain of the digital broadcast data by analyzing the audio data of the compressed domain of the digital broadcast data when the broadcast data is the digital broadcast data; and
detecting an important event by analyzing the event candidate domain of at least one of the analog broadcast data and the digital broadcast data.

17. The method of claim 16, wherein the detecting of the event candidate domain comprises:
detecting a shot change by analyzing the video data of the uncompressed domain of the analog broadcast data;
performing the detecting of the event candidate domain of the video data of the uncompressed domain of the analog broadcast data by analyzing a key frame according to the detected shot change; and
processing the audio data of the event candidate domain by analyzing the audio data of the uncompressed domain of the analog broadcast data.

18. The method of claim 16, wherein the detecting of the event candidate domain comprises:
detecting a shot change by analyzing the video data of the compressed domain of the digital broadcast data;
checking whether the video data of the compressed domain of the digital broadcast data is an HD broadcast data by using the key frame according to the detected shot change;
extracting a DC image from the video data of the compressed domain of the digital broadcast data when the video data is the HD broadcast data;
decoding the data of the compressed domain of the digital broadcast data when the compressed domain data is not the HD broadcast data;
performing the detecting of the event candidate domain by analyzing the decoded data or the extracted DC image; and
performing the detecting of the event candidate domain by analyzing the audio data of the compressed domain of the digital broadcast data.

19. The method of claim 18, further comprising:
controlling a frame size of the decoded video data of the compressed domain of the digital broadcast data into an appropriate size to detect the event candidate domain of a video event.

20. The method of claim 18, further comprising:
demultiplexing the digital broadcast data into the video data of the compressed domain of the digital broadcast data and the audio data of the compressed domain of the digital broadcast data.

21. At least one medium comprising computer readable code to control at least one processing element to implement a broadcast program summary generation method comprising:
transforming a broadcast format of digital broadcast data into a storage format;
decoding video data of the transformed digital broadcast data; to analyze the decoded video data
detecting an important event by analyzing audio data of the transformed digital broadcast data; and
generating summary information based on the important event.
